(19) United States
(12) Patent Application Publication
(10) Pub. No.: US 2026/0184199 A1
(43) Pub. Date: Jul. 2, 2026

(54) POWER CONSUMPTION PREDICTIVE ANALYSIS AND IMPROVEMENT SUGGESTION SYSTEM FOR BATTERY ELECTRIC VEHICLE USING LARGE LANGUAGE MODEL

(71) Applicant: TOYOTA JIDOSHA KABUSHIKI KAISHA, Toyota-shi (JP)

(72) Inventors: Jiawei YONG, Tokyo (JP); Akie WATANABE, Tokyo (JP); Yusuke YAMAURA, Tokyo (JP); Kimi SUGAWARA, Tokyo (JP)

(73) Assignee: TOYOTA JIDOSHA KABUSHIKI KAISHA, Toyota-shi (JP)

(21) Appl. No.: 19/414,381

(22) Filed: Dec. 10, 2025

(30) Foreign Application Priority Data
Dec. 26, 2024 (JP) 2024-230956

(51) Int. Cl. B60L 50/60

(52) U.S. Cl. CPC B60L 50/60; B60L 2250/00; B60L 2260/54

(57) ABSTRACT

A power consumption predictive analysis and improvement suggestion system for a battery electric vehicle, using a large language model (LLM), includes an estimation unit that estimates, using an LLM, power consumption of a battery that will be consumed on a planned route in the battery electric vehicle equipped with the battery, based on a current traveling state and past traveling history thereof, and that estimates, using the LLM, an improvement approach to bring the power consumption that is estimated closer to a minimum value, and a suggestion unit that suggests the improvement approach that is estimated to the driver.

### CROSS-REFERENCE TO RELATED APPLICATION

This application claims priority to Japanese Patent Application No. 2024-230956 filed on Dec. 26, 2024. The disclosure of the above-identified application, including the specification, drawings, and claims, is incorporated by reference herein in its entirety.

### BACKGROUND

### 1. Technical Field

The present disclosure is applicable to, for example, battery electric vehicles (so-called BEVs) and so forth that use batteries, and relates to the technical field of a system that performs predictive analysis of power consumption of a battery and suggests improvements to the power consumption as needed such that the vehicle can reach a destination thereof.

### 2. Description of Related Art

As technology related to this type of system, a cruising range notification device has been developed for an automotive navigation system for a battery electric vehicle, in which the device displays a remaining cruising range indicating how far the vehicle can travel based on remaining charge of an in-vehicle battery, and performs notification regarding whether the vehicle can return to home or to a predetermined charging facility (see WO14/188652).

### SUMMARY

However, according to the background art described above, there is a high possibility that a user or a driver will not be convinced by an automotive navigation system simply displaying information regarding remaining cruising range and whether the destination can be reached. There are also issues with precision and correctness of the information displayed in this way. In particular, without a detailed breakdown of power consumption and an explanation of the influence of each element, it is unclear which part is most problematic. Also, there is a technical problem in that a satisfactory approach cannot be suggested in the event that the destination cannot be reached.

An object of the present disclosure is to provide a power consumption predictive analysis and improvement suggestion system for a battery electric vehicle, using an LLM, which can predict power consumption with prediction precision that is more correct, and suggest improvement approaches regarding power consumption in natural language that humans can understand.

In order to solve the above problems, according to an aspect of the present disclosure, a power consumption predictive analysis and improvement suggestion system for a battery electric vehicle, using a large language model (LLM), includes an estimation unit that estimates, using an LLM, power consumption of a battery that will be consumed on a planned route when traveling to a destination in the battery electric vehicle equipped with the battery, based on information related to a driver and traveling of the battery electric vehicle, including a current traveling state and past traveling history of the battery electric vehicle, and past traveling history of battery electric vehicles of a same model as the battery electric vehicle, and that also estimates, using the LLM, an improvement approach to bring the power consumption that is estimated closer to a minimum value, and a suggestion unit that suggests the improvement approach that is estimated to the driver.

According to one aspect of the system according to the present disclosure, using LLM enables predicting power consumption with prediction precision that is more correct, through high-dimensional learning including text, and suggesting improvement approaches to improve power consumption, in natural language that humans can understand.

Such advantageous effects of the present disclosure will become more apparent from the embodiments of the disclosure described below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an overall configuration of a system according to an embodiment; and

FIG. 2 is a flowchart showing an example of processing in the system according to the embodiment.

### DETAILED DESCRIPTION OF EMBODIMENTS

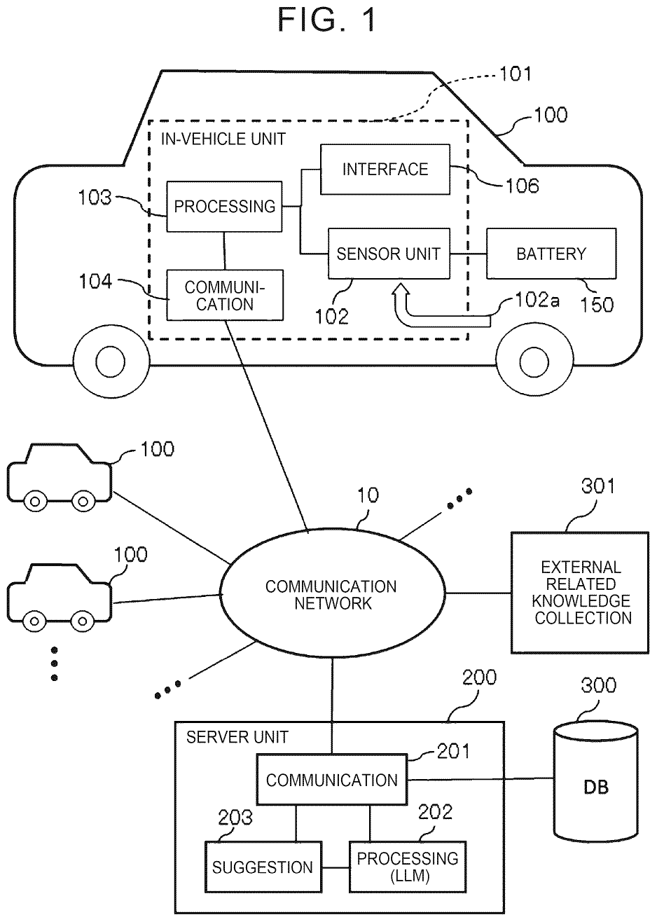

First, an overall configuration of a power consumption predictive analysis and improvement suggestion system for a battery electric vehicle using a large language model (LLM) according to an embodiment (hereinafter simply referred to as “analysis and improvement suggestion system” as appropriate) will be described with reference to FIG. 1.

The LLM used for analysis and estimation according to the present embodiment, or used for suggestions through linguistics, may be a so-called single-modal LLM or may be a multi-modal LLM. The present embodiment is constructed as a system that performs LLM analysis or AI analysis based on, for example, LLM learning data that appropriately includes various types of information such as traveling state, past traveling history, and specifications of the battery electric vehicle, various types of information related to traveling paths on a planned route or to maps, information related to the past traveling history of battery electric vehicles of the same model as or similar to the battery electric vehicle, various types of personal information related to a user or a driver of the battery electric vehicle (i.e., users or drivers of the battery electric vehicle and other battery electric vehicles), information of traffic laws and common knowledge related to traffic laws, information of general common knowledge, and so forth.

Specifically, the system is constructed to suggest highly precise information regarding remaining cruising range and whether the destination can be reached, based on the remaining charge of the battery, traveling method, driving operations, and so forth, in a manner that readily convinces the user or the driver, which will be described in detail below. Further, providing a detailed breakdown of power consumption and explaining the influence of each element in this manner enables the user or the driver to clearly understand which part is most problematic. Furthermore, the system is constructed to be able to suggest approaches in the event that the destination cannot be reached.

Note that such AI learning or LLM learning can employ traditional AI learning systems, such as so-called supervised learning, unsupervised learning, or reinforcement learning, as well as new technologies such as generative AI, LLMs, and so forth, that have recently been put into practical use, that are currently under development, or that will be developed in the future. For example, AI learning or LLM learning here may be configured using a neural network that performs efficient learning through representation learning, transfer learning, feature selection, fine tuning or hyperparameter tuning, ensemble learning, or the like.

As illustrated in FIG. 1, the analysis and improvement suggestion system according to the embodiment is configured including an in-vehicle unit 101 installed in a battery electric vehicle 100, and a server unit 200. The in-vehicle unit 101 and the server unit 200 are accommodated in a communication network 10 such as the Internet, a dedicated network, or the like. The communication network 10 also accommodates a plurality of or a great number of other battery electric vehicles 100 in the same way. Further, the communication network 10 also accommodates an external related knowledge collection unit 301 that collects information obtained outside the battery electric vehicle 100 and that can be subjected to execution of fine tuning or hyper tuning in the analysis and improvement suggestion system and used to impart domain knowledge (i.e., “external related knowledge”). The external related knowledge collection unit 301 may be provided at least in part within the server unit 200 or within a facility in which the server unit 200 is located, or may be provided within the in-vehicle unit 101 or within the vehicle.

The server unit 200 is connected to a database 300 in which various types of data, including data used in the analysis and improvement suggestion system, are stored. The database 300 may be connected to the server unit 200 or the in-vehicle unit 101 via the communication network 10. The server unit 200 is made up including various types of computer-installed devices and various types of computer devices that perform centralized processing or distributed processing, and in other words, the analysis and improvement suggestion system is constructed as a system that performs centralized processing or distributed processing using the large-scale data in the databases 300.

In FIG. 1, the battery electric vehicle 100 includes a battery 150 and is configured as, for example, a BEV. The battery electric vehicle 100 may also be a so-called hybrid electric vehicle (HEV), a plug-in HEV (PHEV), a fuel cell EV (FCEV), or the like, which uses a battery.

The in-vehicle unit 101 is configured including a sensor unit 102 that includes various types of sensors laid out at predetermined positions within the vehicle, a processing unit 103 that includes a computer, a communication unit 104 that includes a modem or the like configured to be capable of external communication from the vehicle via the communication network 10, and an interface unit 106 that is configured to be capable of interchange with the user or driver inside the vehicle by speech and images.

As one of the detection functions thereof, the sensor unit 102 detects remaining charge data of the battery 150 and passes the data to the processing unit 103. The sensor unit 102 is also configured to detect various types of information 102a related to the current traveling state of the battery electric vehicle 100 and the driver of the battery electric vehicle 100, and pass this information to the processing unit 103 as controller area network (CAN) data or the like.

The processing unit 103 has a CPU that controls the sensor unit 102, the communication unit 104, and the interface unit 106, memory, and so forth, and transmits various types of information related to the driver and traveling of the battery electric vehicle 100, including a planned route of the battery electric vehicle 100, the current traveling state and past traveling history of the battery electric vehicle 100, from the communication unit 104 to the server unit 200 side, as data in a predetermined format. Further, the interface unit 106 is configured to suggest to the user or the driver, via the communication unit 104, improvement approaches and so forth, indicated by improvement approach data and so forth that is received from the server unit 200 side after processing thereat.

Under the control of the processing unit 103, the communication unit 104 transmits data, collected by the battery electric vehicle 100, that is necessary for power consumption predictive analysis and improvement suggestions, to the server unit 200 via the communication network 10. Further, the server unit 200 is configured to receive, via the communication network 10, the results of the power consumption predictive analysis of the battery electric vehicle 100 generated using the LLM, and data related to improvement suggestions.

The interface unit 106 is configured to enable input of the destination of the battery electric vehicle 100, conditions for selecting a planned route to the destination, and so forth, by speech input or predetermined operations on an image, or the like. The selection of the planned route here (i.e., navigation function) may be configured such that all or part thereof is executed by the processing unit 103, or such that part or all thereof is executed by a processing unit 202 on the server unit 200 side (in other words, the in-vehicle unit 101 side mainly serves as a browser function). The interface unit 106 is further configured to be able to output the results of the power consumption predictive analysis and data relating to improvement suggestions obtained from the server unit 200 side in a predetermined format, either as speech output or on an image.

In FIG. 1, the server unit 200 is configured including a communication unit 201 that includes a modem or the like that is capable of communicating with each of the battery electric vehicles 100, and also with the external related knowledge collection unit 301 via the communication network 10, a processing unit 202 including a computer that is capable of executing processing such as LLM-based power consumption estimation processing and so forth, which will be described in detail later, and a suggestion unit 203 that is capable of generating suggestion data that suggests improvement approaches in accordance with the estimation results from the processing unit 202.

The communication unit 201 receives, under the control of the processing unit 202, data collected by the battery electric vehicle 100, that is necessary for power consumption predictive analysis and improvement suggestions, via the communication network 10. Under the control of the processing unit 202, the communication unit 201 receives the external related knowledge collected by the external related knowledge collection unit 301 via the communication network 10, as part of the data required for power consumption predictive analysis and improvement suggestions. The communication unit 201 is further configured to transmit, to the battery electric vehicle 100 that is the subject of this analysis, the results of the power consumption predictive analysis and data related to improvement suggestions, which have been processed and generated by the processing unit 202 and the suggestion unit 203, to the battery electric vehicle 100 side via the communication network 10.

The processing unit 202 is configured to use the LLM to estimate the battery power consumption that will be consumed on the planned route when the battery electric vehicle 100 that is the subject of this analysis travels to the destination thereof, based on information related to the driver and traveling of the battery electric vehicle 100, including the current traveling state and past traveling history of the battery electric vehicle 100, and the past traveling history of other battery electric vehicles 100 of the same model as the battery electric vehicle 100, and also to use the LLM to estimate improvement approaches that will bring the power consumption estimated here closer to the minimum value.

The suggestion unit 203 is configured to generate suggestion data for suggesting the improvement approaches estimated in this way to the driver or the user of the battery electric vehicle 100, in a predetermined format corresponding to the interface unit 106 provided inside the battery electric vehicle 100, and to pass the data to the communication unit 201. In the present embodiment, the “suggestion unit” is thus configured to include the suggestion unit 203 on the server unit 200 side and the interface unit 106 on the in-vehicle unit 101 side, and the in-vehicle unit 101 side is mainly responsible for the browser function with regard to the suggestion function.

The database 300 is configured to include a large-scale, high-speed data input/output storage device that stores various types of data received by the server unit 200 side via the communication network 10, in particular various types of data required for estimation processing using the LLM, data related to the estimation results or intermediate progress generated by the processing unit 202, suggestion data generated by the suggestion unit 203, and so forth.

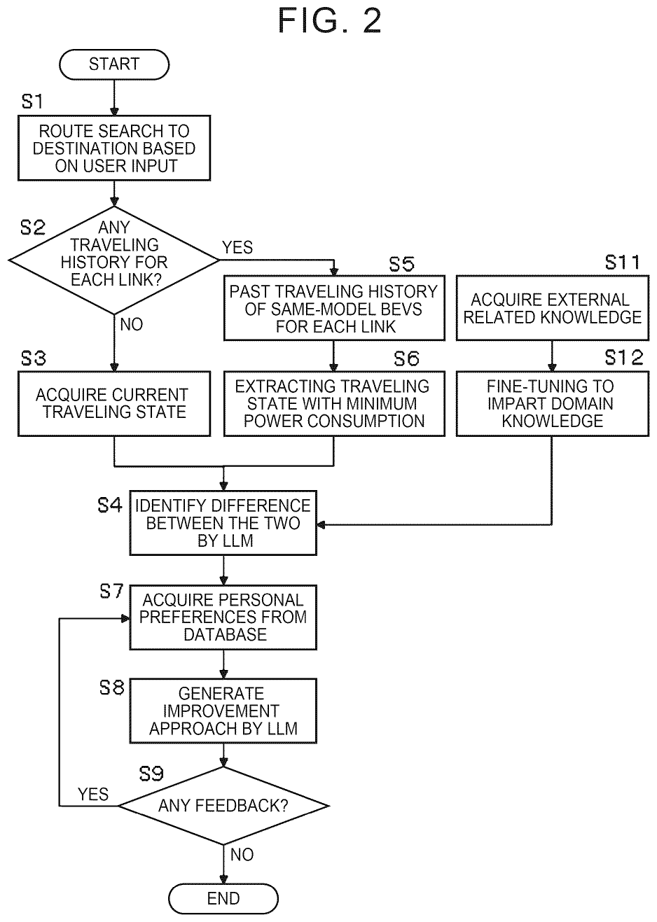

Next, referring to the flowchart in FIG. 2 in addition to the block diagram in FIG. 1, an example of processing in the analysis and improvement suggestion system according to the present embodiment (in particular, processing executed using the LLM in the processing unit 202 in the server unit 200) will be described.

In FIG. 2, first, the user inputs the “destination” for this traveling using the browser function of the navigation device in the interface unit 106 of the in-vehicle unit 101. The processing unit 103 or the processing unit 202 via the communication network 10 then searches for a route to the destination (step S1).

Next, the processing unit 202 in the server unit 200 determines whether there is a travel history for each link of the planned route that has been searched for (step S2). Part or all of such determination functions may be executed by the processing unit 103 in the in-vehicle unit 101 side. Data relating to the traveling history is basically stored in the database 300. Note that part of the data relating to the traveling history may be stored in memory included in the processing unit 103 on the in-vehicle unit 101 side or in in-vehicle memory provided separately from the processing unit 103.

When the result of the determination in step S2 is that there is no traveling history (No in step S2), the “current traveling state” is acquired by the sensor unit 102 and the processing unit 103 on the in-vehicle unit 101 side, and passed to the processing unit 202 on the server unit 200 side (step S3). Thereafter, the processing proceeds to processing such as estimating an improvement approach using LLM in the processing unit 202, or the like (step S4 and thereafter).

On the other hand, when the result of the determination in step S2 is that there is traveling history (Yes in step S2), the processing unit 202 acquires “past traveling history of BEVs of the same model as the battery electric vehicle 100 for each link” from the database 300 or the like (step S5). Now, a “BEV of the same model” can include not only a BEV of exactly the same type or same model as the BEV owned by the drive or the user, but also a BEV having common specifications or similar specifications that are set in advance. For example, when the powertrains of both vehicles are the same or navigation numbers are the same, they can be treated as being the same model here. Furthermore, slight differences between the two vehicles may be corrected by the LLM such that they can be treated as vehicles of the same model, and the corrected traveling history may then be used in the processing relating to power consumption (step S6 and thereafter).

Next, the processing unit 202 extracts, from the past traveling history thus obtained, a value corresponding to “minimum power consumption” (step S6). Thereafter, the processing proceeds to processing such as estimating an improvement approach using LLM in the processing unit 202, or the like (step S4 and thereafter). Here, in order to estimate improvement approaches using LLM based on past traveling history (step S4 and thereafter), relationship graphs and numerical data between elements and power consumption, accumulated for each road link, are all converted into text by the LLM, and then subjected to vectorization processing.

The external related knowledge collection unit 301 acquires external related knowledge in parallel with, before, or after the processing of steps S1 to S6 described above (step S11), and processing of performing fine tuning or hyper tuning to impart domain knowledge is executed by the processing unit 202 (step S12). Thereafter, the processing proceeds to processing such as estimating an improvement approach using LLM in the processing unit 202, or the like (step S4 and thereafter). Thus, using an LLM that has been fine-tuned with domain knowledge related to battery electric vehicles, such as BEV domain knowledge or the like enables improvement approaches to be generated by comparing with optimal traveling settings.

Next, the processing unit 202 executes estimation processing for identifying difference between the travelling state acquired in step S3 described above and the travelling state extracted in step S6 described above (step S4). The identification of the difference using the LLM here is performed based on the domain knowledge imparted in step S12 described above, in addition to the various types of data obtained from the in-vehicle unit 101 and the various types of data acquired or extracted from the database.

Next, data relating to personal preferences that has been stored in the database 300 in the past, as data unique to the driver of the battery electric vehicle 100 is acquired from the database 300 and passed to the processing unit 202 (step S7).

Next, based on the various types of data acquired or generated in steps S3, S4, S6, S7, and so forth, which are described above, the processing unit 202 generates a power consumption improvement approach through estimation using the LLM (step S8). Here, an improvement approach that brings the power consumption closer to the minimum value is estimated by LLM, as an improvement approach.

The LLM that is run in steps S4 and S8 described above uses, as the great amount of text data, various types of information including as appropriate, for example, traveling state, past traveling history, and specifications of the battery electric vehicle 100, various types of information related to traveling paths on a planned route or to maps, information related to the past traveling history of battery electric vehicles of the same model as or similar to the battery electric vehicle 100, various types of personal information related to the user or the driver of the battery electric vehicle 100 (i.e., users or drivers of the battery electric vehicle 100 and other battery electric vehicles 100), information of traffic laws and common knowledge related to traffic laws (e.g., which side of the road to drive on, speed limits in residential areas, and so forth), and information of general common knowledge (e.g., it is dark at night, traffic jams are likely to occur during rush hours and during consecutive holidays, the presence of landmarks near the planned route, and so forth), and a large amount of such information that is verbalized is used.

Note, however, that a multimodal LLM that is capable of AI learning based not only on verbalized information but also on non-verbalized information may be adopted in these steps S4, S8, and so forth. That is to say, the data used in the processing of steps S4, S8, and so forth includes text data, but is not limited to text data.

In the processing of steps S4, S8, and so forth described above, a large amount of text data is used in this way to perform fine tuning and so forth of the LLM. As a result, application can be made to various types of natural language processing (NLP) tasks such as text classification, sentiment analysis, information extraction, text summarization, text generation, question answering, and so forth.

In step S8, the suggestion unit 203 further generates suggestion data to suggest the improvement approaches generated by the LLM, and the “improvement approaches” are output as speech or as images by the interface unit 106 on the in-vehicle unit 101 side. In addition, the processing unit 202 and the suggestion unit 203 also output suggestion data for suggesting “grounds” for the improvement approaches as speech or as images on the interface unit 106. Note that it is also preferable to use the LLM to execute generating of suggestion data for outputting the improvement approaches and so forth as speech or as images by the suggestion unit 203. That is to say, suggestions by AI speech and AI images may be made to the user or the driver in accordance with various types of natural language processing tasks such as text classification, sentiment analysis, information extraction, text summarization, text generation, and question answering, here as well.

Next, determination is made regarding whether there is feedback (step S9), and when there is (YES in step S9), the processing returns to step S7 and the subsequent steps are repeatedly executed, and “improvement approaches” updated through AI learning are suggested (step S8).

The improvement approaches that are suggested here include, for example, “To reduce power consumption on this expressway, keep in the cruising lane and drive at a steady speed of 80 km/h,” “The remaining charge of the battery is low, so please refrain from sudden acceleration and deceleration until the next charge,”, “Continue along the road to charge at the charging station 25 km ahead”, and so forth. Ultimately, the interface unit 106 on the in-vehicle unit 101 side will suggest such information to the driver in the form of AI speech or AI images, through speech output or image output.

In the present embodiment, it is preferable to suggest the grounds for the improvement approach along with the suggestion of the improvement approach, from the perspective of convincing the user or the driver, in other words, from the perspective of causing the driver to follow the improvement approach. Examples of the grounds for suggestions here include, “(The grounds are that) the gas mileage of this car is best at 80 km/h,” “(The grounds are that) accelerating and decelerating repeatedly from now on will deplete the charge before reaching the next charging station,” and “(The grounds are that) there is no problem driving as usual to reach the charging station 25 km away,” and so forth.

When determination is made in step S9 that there is no feedback (No in step S9) after the processing of suggesting such improvement approaches, the series of processing ends.

As described above in detail, according to the present embodiment, the past traveling history of battery electric vehicles such as BEVs of the same type, or the like, is extracted for each road link (steps S5 and S6), the relationship between traveling state (air conditioning, vehicle speed, vehicle weight, in-cabin temperature, and so forth) and power consumption is input to the LLM (step S3), the difference between the traveling state with the minimum power consumption and the current settings is output from the LLM (step S4), and improvement approaches for conserving power (i.e., improvements for bringing the power consumption closer to the minimum value) are suggested verbally or by speech (steps S7 and S8).

Additionally, in response to user feedback (step S9), improvement approaches that take personal preferences into greater consideration can be suggested from the next time onwards (steps S7 and S8). Thus, LLM-specific feedback mechanisms such as reinforcement learning from human feedback (RLHF) or the like can be utilized to reflect personal preferences. This enables collecting feedback on each element that has influence on power consumption and generating new improvement approaches that are more tailored to the individual.

Thus, according to the present embodiment, using LLM enables not only extracting numerical data such as in the conventional technology or background art or the like, but also extracting relevant features from text data such as papers and related literature, and accordingly power consumption can be calculated or estimated at a higher dimension. Further, according to the present embodiment, using LLM enables results, grounds, and improvement approaches to be simultaneously provided to the user in natural language or speech, thereby increasing the convincement and satisfaction of the user with the reply.

### Appendices

The following appendices are further disclosed regarding the above-described embodiment.

### Appendix 1

In a battery electric vehicle equipped with a battery, a power consumption predictive analysis and improvement suggestion system according to Appendix 1 of the present disclosure includes an estimation unit that estimates, using an LLM, power consumption of the battery that will be consumed on a planned route when traveling to a destination in the battery electric vehicle equipped with the battery, based on information related to a driver and traveling of the battery electric vehicle, including a current traveling state and past traveling history of the battery electric vehicle, and past traveling history of battery electric vehicles of a same model as the battery electric vehicle, and that also estimates, using the LLM, an improvement approach to bring the power consumption that is estimated closer to a minimum value, and a suggestion unit that suggests the improvement approach that is estimated to the driver.

According to the analysis and improvement suggestion system in Appendix 1, using the LLM enables high-dimensional learning including text or also including text to be used to predict power consumption with prediction precision that is more correct, and elements that have the greatest influence on power consumption, and improvement approaches, can also be described in natural language that humans can understand. This also enables the traveling history that is collected to be provided as useful information for other vehicles.

### Appendix 2

The analysis and improvement suggestion system of Appendix 2 of the present disclosure is the power consumption predictive analysis and improvement suggestion system according to Appendix 1, in which the estimation unit estimates the improvement approach by identifying a difference between a current traveling state and a traveling state with minimum power consumption in the past traveling history, using the LLM.

According to the analysis and improvement suggestion system in Appendix 2 of the present disclosure, using the LLM to identify difference between the current traveling state and the traveling state with minimum power consumption in the past traveling history enables relatively efficient estimation of improvement approaches to bring power consumption closer to the minimum value.

### Appendix 3

The analysis and improvement suggestion system of Appendix 3 of the present disclosure is the power consumption predictive analysis and improvement suggestion system according to Appendices 1 or 2, in which the estimation unit acquires external related knowledge other than information related to the current traveling state and the past traveling history, and estimates the improvement approach taking into consideration domain knowledge related to the battery electric vehicle using an LLM that is fine-tuned using the external related knowledge that is acquired.

According to the analysis and improvement suggestion system in Appendix 3 of the present disclosure, improvement approaches are estimated not only based on information related to the current traveling state and the past traveling history, but also taking domain knowledge into consideration with an LLM that is fine-tuned using external related knowledge, thereby enabling estimation with higher precision.

### Appendix 4

The analysis and improvement suggestion system of Appendix 4 of the present disclosure is the power consumption predictive analysis and improvement suggestion system according to any one of Appendices 1 to 3, in which the estimation unit acquires information related to personal preferences of the driver of the battery electric vehicle, and estimates the improvement approach using the LLM in a way that reflects personal preferences by utilizing an LLM-dedicated mechanism for feedback of the information related to the personal preferences that is acquired.

According to the analysis and improvement suggestion system in Appendix 4 of the present disclosure, improvement approaches are estimated by the LLM not only based on information relating to the current traveling state and the past traveling history but also in a form that reflects personal preferences, and accordingly suggesting of highly precise improvement approaches that are suitable for the driver or the user can be performed in a more convincing manner.

### Appendix 5

The analysis and improvement suggestion system of Appendix 5 of the present disclosure is the power consumption predictive analysis and improvement suggestion system according to any one of Appendices 1 to 4, in which the suggestion unit suggests, along with the improvement approach, information indicating grounds for estimating the improvement approach.

According to the analysis and improvement suggestion system in Appendix 5 of the present disclosure, not only improvement approaches but also the grounds for the improvement approaches are suggested, thereby enabling highly precise improvement approaches to be suggested in a form that is easier for the driver or the user to understand.

### Appendix 6

In a battery electric vehicle equipped with a battery, an analysis and improvement suggestion system according to Appendix 6 of the present disclosure includes estimating, using an LLM, power consumption of a battery that will be consumed by driving on a planned route when traveling to a destination, based on information relating to a driver of the battery electric vehicle and to traveling, including a current traveling state and past traveling history of the battery electric vehicle, and past traveling history related to battery electric vehicles of a same model as the battery electric vehicle, and also estimating, using the LLM, an improvement approach to bring the power consumption that is estimated closer to a minimum value, and suggesting the improvement approach that is estimated to the driver.

According to the analysis and improvement suggestion method in Appendix 6 of the present disclosure, similar to the analysis and improvement suggestion system described in Appendix 1, using the LLM enables high-dimensional learning including text or also including text to be used to predict power consumption with prediction precision that is more correct, and elements that have the greatest influence on power consumption, and improvement approaches, can also be described in natural language that humans can understand.

The present disclosure can be modified as appropriate within a scope that does not contradict the gist or idea of the disclosure that can be read from the claims and the entire specification, and the analysis and improvement suggestion system and method, involving such modifications, are also included in the technical idea of the present disclosure.

What is claimed is:

1. A power consumption predictive analysis and improvement suggestion system for a battery electric vehicle, using a large language model (LLM), the power consumption predictive analysis and improvement suggestion system comprising:
an estimation unit that estimates, using an LLM, power consumption of a battery that will be consumed on a planned route when traveling to a destination in the battery electric vehicle equipped with the battery, based on information related to a driver and traveling of the battery electric vehicle, including a current traveling state and past traveling history of the battery electric vehicle, and past traveling history of battery electric vehicles of a same model as the battery electric vehicle, and that also estimates, using the LLM, an improvement approach to bring the power consumption that is estimated closer to a minimum value; and
a suggestion unit that suggests the improvement approach that is estimated to the driver.

2. The power consumption predictive analysis and improvement suggestion system according to claim 1, wherein the estimation unit estimates the improvement approach by identifying a difference between the current traveling state and a traveling state with minimum power consumption in the past traveling history, using the LLM.

3. The power consumption predictive analysis and improvement suggestion system according to claim 1, wherein the estimation unit acquires external related knowledge other than information related to the current traveling state and the past traveling history, and estimates the improvement approach taking into consideration domain knowledge related to the battery electric vehicle using an LLM that is fine-tuned using the external related knowledge that is acquired.

4. The power consumption predictive analysis and improvement suggestion system according to claim 1, wherein the estimation unit acquires information related to personal preferences of the driver of the battery electric vehicle, and estimates the improvement approach using the LLM in a way that reflects the personal preferences by utilizing an LLM-dedicated mechanism for feedback of the information related to the personal preferences that is acquired.

5. The power consumption predictive analysis and improvement suggestion system according to claim 1, wherein the suggestion unit suggests, along with the improvement approach, information indicating grounds for estimating the improvement approach.

6. A power consumption predictive analysis and improvement suggestion method for a battery electric vehicle, using a large language model (LLM), the power consumption predictive analysis and improvement suggestion method comprising:
estimating, using an LLM, power consumption of a battery that will be consumed on a planned route when traveling to a destination in a battery electric vehicle equipped with the battery, based on information related to a driver and traveling of the battery electric vehicle, including a current traveling state and past traveling history of the battery electric vehicle, and past traveling history of battery electric vehicles of a same model as the battery electric vehicle, and estimating, using the LLM, an improvement approach to bring the power consumption that is estimated closer to a minimum value; and
suggesting the improvement approach that is estimated to the driver.
